(19) United States
(12) Patent Application Publication
(10) Pub. No.: US 2026/0300512 A1
(43) Pub. Date: Oct. 1, 2026

(54) STRUCTURED DATA IDENTIFICATION IN CONTENT SCANNED FOR DATA LOSS PREVENTION

(71) Applicant: Palo Alto Networks, Inc., Santa Clara, CA (US)

(72) Inventor: Nilesh Girsh Telang, Sunnyvale, CA (US)

(21) Appl. No.: 19/090,921

(22) Filed: Mar. 26, 2025

(51) Int. Cl. G06F 21/60; G06F 21/62

(52) U.S. Cl. CPC G06F 21/602; G06F 21/6209

(57) ABSTRACT

A system infers the presence of structured data within content submitted for data loss prevention (DLP) scanning to provide increased confidence in sensitive data detections. A first technique identifies sequences that correspond to structured data represented in text-based files. A second technique identifies sequences that correspond to a structured data in text extracted from images non-text-based files. In each case, the system obtains results of DLP scanning that indicate each detected keyword related to sensitive data and the corresponding value(s) detected as being potentially sensitive. For each keyword, the system iterates over the corresponding value(s) and evaluates positions of the corresponding values relative to at least one of a position of the keyword and a position of a preceding value based on criteria for adding values to a sequence. The system validates each resulting sequence and indicates the potentially sensitive data in valid sequences inferred to correspond to structured data.

### BACKGROUND

The disclosure generally relates to data processing (e.g., CPC subclass G06F) and to text processing (e.g., CPC subclass G06F 40/10).

Data loss prevention (DLP) tools are used by organizations to prevent the unauthorized or unsafe exposure of data to those outside of the organization. DLP tools work to prevent loss of data by monitoring data in motion, data in use, and data at rest (collectively “data”). Data in motion refers to data that is actively in transit (e.g., over a network) between locations. Data in use refers to data being accessed, processed, or otherwise manipulated in memory. Data at rest refers to data in storage that is not actively in transit or being accessed.

### BRIEF DESCRIPTION OF THE DRAWINGS

Embodiments of the disclosure may be better understood by referencing the accompanying drawings.

FIG. 1 is a conceptual diagram of determining that DLP detections within unstructured text correspond to structured data.

FIG. 2 is a conceptual diagram of determining that DLP detections within text extracted from a non-text-based file type correspond to structured data.

FIGS. 3A-3B are a flowchart of example operations for inferring structure of potentially sensitive data detected within unstructured text scanned for DLP.

FIGS. 4A-4C are a flowchart of example operations for inferring structure of potentially sensitive data detected within content from which text was extracted for DLP scanning.

FIG. 5 is a flowchart of example operations for determining a two-dimensional position of an entity in text scanned for DLP.

FIG. 6 is a flowchart of example operations for performing strict validation of generated sequences of values inferred to correspond to structured data.

FIG. 7 depicts an example computer system with a structured data inferencing system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

While DLP solutions for detecting potentially sensitive data and computing a confidence for the detection exist for tabular data stored in formats known to be associated with tabular data, such as data stored in a spreadsheet or a comma-separated values (CSV) file, tabular data—or other structured data—may be present in other file formats or within otherwise unstructured text. For instance, an image submitted for DLP scanning can comprise an image of a table, or a portable document format (PDF) file submitted for scanning may have both text and a table(s) containing data included therein. Determining confidence in detections of potentially sensitive data within tabular data in such formats thus presents a challenge, as a DLP scanner will not recognize the data as being formatted in a table and thus will not apply specific DLP scanning techniques for tabular data. Detections of potentially sensitive data within columns corresponding to a keyword identified from DLP scanning will thus have increasingly low confidence with increasing row numbers for the column that may not trigger remediation. This arises because standard DLP scanning for non-tabular data formats computes a one-dimensional or linear distance of detections relative to the corresponding keyword (an “offset”), such as the number of characters between a detected keyword “SSN” and the corresponding value suspected to be a social security number (SSN). While useful for determining confidence of detections found within a sentence or paragraph, sensitive data included in columns corresponding to a keyword will have a lower confidence in their detection when the one-dimensional positioning is used.

Disclosed herein are techniques for improved confidence in detections of potentially sensitive data in structured data, such as tabular data, within unstructured data. Two techniques for heuristically identifying structured data in content submitted for DLP scanning to provide increased confidence in sensitive data detections from DLP are disclosed. A first technique aids in identifying sequences that correspond to columns in a table or other structured data represented in text-based files, and the other identifies sequences that correspond to a table or other structured data in text extracted from (e.g., with optical character recognition (OCR)) images or proprietary, non-text-based files. In each case, a structured data inferencing system (“the system”) obtains results of DLP scanning that indicate each detected keyword related to sensitive data and the corresponding value(s) associated with the keyword detected as being potentially sensitive. For each keyword, the system iterates over the corresponding value(s) and evaluates positions of each corresponding value in the text relative to at least one of a position of the keyword and a position of a preceding value (i.e., a value with a lower offset) based on criteria for adding values to a sequence inferred to correspond to structured data. The system validates each resulting sequence based on various criteria, such as a sequence length criterion, and indicates that the potentially sensitive data identified in valid sequences are inferred to correspond to structured data. DLP verdicts that are ultimately generated can thus indicate the values inferred to correspond to structured data as high confidence detections. As a result, sensitive data presented as structured data in otherwise unstructured data, whether in text form, in an image, or otherwise, will not be bypassed for remediation.

### Example Illustrations

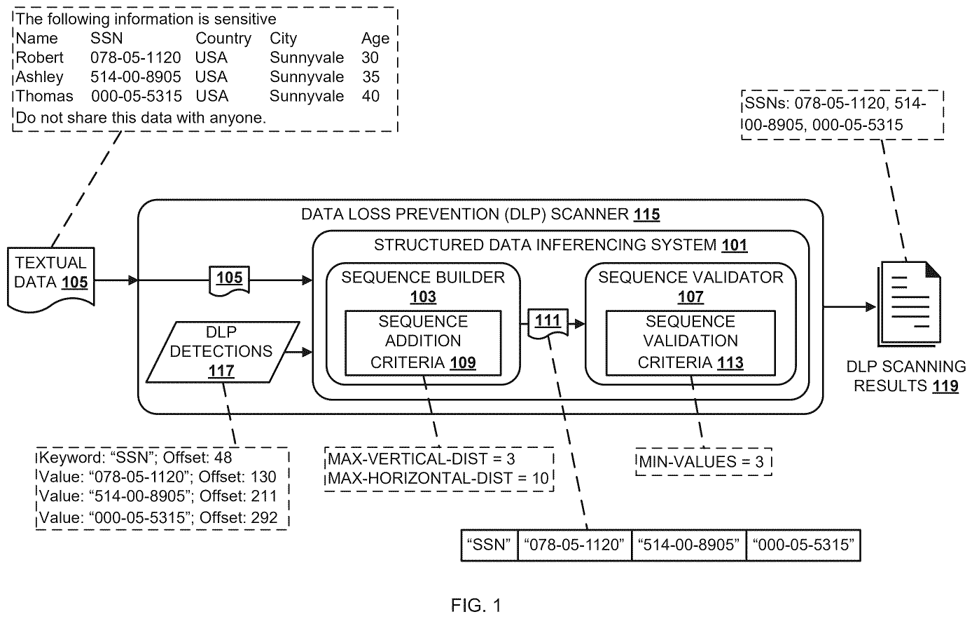

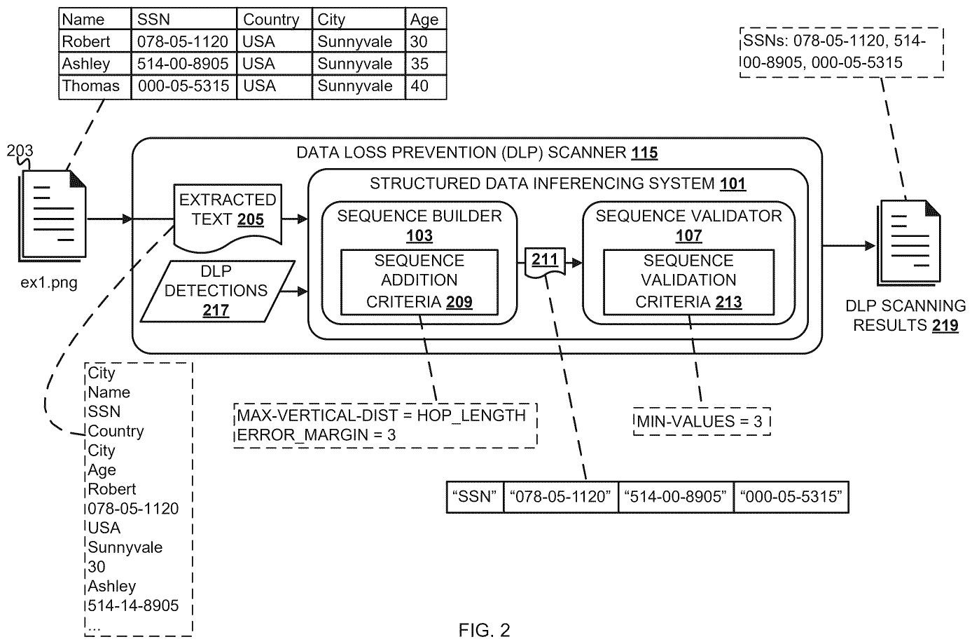

FIG. 1 is a conceptual diagram of determining that DLP detections within unstructured text correspond to structured data. A DLP scanner 115 performs DLP scanning on content submitted thereto. The DLP scanner 115 may communicate with or be incorporated as part of a cybersecurity appliance (not depicted in FIG. 1) that scans detected network traffic for sensitive data, executes client-side, on a server to which a client submits content for DLP scanning, etc. The DLP scanner 115 comprises a structured data inferencing system (“system”) 101. The system 101 analyzes keywords and values detected as potentially sensitive by the DLP scanner 115 with types corresponding to a keyword to infer the presence of structured data and thus to increase confidence in the detections corresponding to the structured data. The system 101 can analyze plaintext (e.g., in messages comprising text) and text-based file formats (e.g., text files, word processing documents, etc.) as well as text extracted from (e.g., with OCR) images, PDF documents, or other proprietary, non-text-based file types. FIG. 1 depicts an example in which the system 101 analyzes textual data (e.g., a text file), while FIG. 2 depicts an example in which the system 101 analyzes text extracted from a Portable Network Graphic (PNG) file.

In this example, textual data 105, which may be plaintext input by a user, included in a text file, or similar, is submitted to the DLP scanner 115 to obtain DLP detections 117. The textual data 105 may have been detected from user input, by a cybersecurity appliance (e.g., a firewall) that submitted the textual data 105 for DLP scanning, etc. The textual data 105 comprises the following example text:

The following information is sensitive

| Name | SSN | Country | City | Age |
|---|---|---|---|---|
| Robert | 078-05-1120 | USA | Sunnyvale | 30 |
| Ashley | 514-00-8905 | USA | Sunnyvale | 35 |
| Thomas | 000-05-5315 | USA | Sunnyvale | 40 |

Do not share this data with anyone.

The DLP detections 117 indicate that the DLP scanner 115 identified the keyword “SSN” as a keyword indicative of the presence of sensitive data at an offset of 48 characters within the textual data 105. The values “078-05-1120”, “514-00-8905”, and “000-05-5315” at offsets of 130 characters, 211 characters, and 292 characters, respectively, were identified as potentially sensitive data with a type corresponding to the keyword “SSN”; in other words, the DLP scanner 115 identified each of these values as potentially being a SSN.

As can be seen in the example text, the columns named “Name”, “SSN”, “Country”, “City”, and “Age” and the data corresponding to these columns in each row are formatted as a table. However, because the textual data 105 comprises unstructured text, the DLP scanner 115 will process the table as plaintext rather than as if it were formatted as a table. The social security numbers (SSNs) in the lower rows will thus have lower confidence detections by the DLP scanner 115 based on the DLP detections 117 alone due to the increasing difference in offsets between the keyword “SSN” and the SSNs in each row of the table. The system 101 infers that the DLP detections 117 correspond to structured data (namely, tabular data) and thus should be reported as high confidence detections by the DLP scanner 115.

The system 101 obtains the DLP detections 117 and the textual data 105 as inputs. A sequence builder 103 of the system 101 evaluates the DLP detections 117 based on sequence addition criteria (“criteria”) 109 to determine if the DLP detections 117 likely are represented as structured data within the textual data 105. The criteria 109 comprise criteria for positions of values identified in the DLP detections 117 relative to their corresponding keyword and/or previous values that, if satisfied for a value based on its position, result in adding the value to a sequence built for the keyword. The position of a keyword or value as defined in the criteria 109 refers to its line number in the textual data 105 and its offset within that line. To illustrate, the keyword “SSN” is on the second line in the textual data 105 and has an offset of ten characters within that line.

The criteria 109 depicted in this example includes a maximum vertical distance criterion, or a criterion for a vertical distance between two values or between a value and the keyword (i.e., a number of lines therebetween), such as a threshold indicating a maximum permitted number of lines between values or a value and keyword for considering the value part of a sequence. The criteria 109 also include a maximum horizontal distance criterion, or a criterion for a horizontal distance between values and the keyword, where horizontal distance is represented as the difference between offsets of a value and keyword within their respective lines. The horizontal distance criterion can be represented with a threshold indicating a maximum permitted number of characters difference between offsets of a keyword and a value for considering the value part of a sequence. In this example, the criteria 109 comprise a vertical distance criterion represented with a threshold having a value of three and a horizontal distance criterion represented with a threshold having a value of ten. Thus, a value that is more than four lines apart from the keyword or previous value and/or with a horizontal offset in its line that differs from the horizontal offset of the keyword by more than ten characters does not satisfy the criteria 109 and will not be added to a sequence for inferred structured data.

For each of the values in the DLP detections 117, the sequence builder 103 determines a position of the value in the textual data 105 and evaluates the position of the value relative to the position of a previous value (i.e., the value with the highest offset indicated in the DLP detections 117 that is lower than the value's offset) and/or the position of the keyword based on the criteria 109. For the first value identified in the DLP detections 117, or “078-05-1120”, the sequence builder 103 determines if the position of the value relative to the position of the keyword satisfies the criteria 109. The sequence builder 103 computes a difference between the positions of the value and the keyword, such as by determining differences between their respective line numbers and offsets within the line, and evaluates the difference in positions based on the criteria 109. To illustrate, the system 101 determines if the difference between line numbers of the keyword and value satisfies the vertical distance criterion of the criteria 109 (i.e., does not exceed three) and if the absolute value of the difference between offsets of the keyword and value within their respective lines satisfies the horizontal distance criterion of the criteria 109 (i.e., does not exceed ten). This example assumes that the difference satisfies the criteria 109, and the sequence builder 103 adds the value “078-05-1120” to a sequence 111 of values built for the keyword “SSN.” The sequence 111 can be implemented with a data structure that stores the keyword in a first element or with which the keyword is associated as metadata (e.g., with a label, tag, etc.).

After initializing the sequence 111 with the value “078-05-1120”, the sequence builder 103 identifies the next value indicated in the DLP detections 117, or “514-00-8905”, and evaluates the position of the value relative to the positions of the previous value “078-05-1120” and the keyword “SSN” based on the criteria 109. For the positions between the values, the sequence builder 103 determines if the difference between line numbers satisfies the vertical distance criterion of the criteria 109. For the position of the value relative to the keyword, the sequence builder 103 determines if the absolute value of the difference between the offset of the keyword “SSN” within its line and the offset of the value “514-00-8905” within its line satisfies the horizontal distance criterion of the criteria 109. This example assumes that the difference in line numbers is one and the difference in horizontal offsets is zero, so the position of the value satisfies the criteria 109. The sequence builder 103 adds the value “514-00-8905” to the sequence 111.

The sequence builder 103 repeats the identification of values in the DLP detections 117 and evaluation of the position of each identified value relative to a position of a preceding value in the sequence 111 and the keyword based on the criteria 109 until either determining that there are no values associated with the keyword remaining for evaluation or determining that a termination criterion is satisfied (e.g., based on a vertical distance between a detected value relative to the last value in the sequence exceeding a threshold). In this example, the sequence builder 103 also adds the value “000-05-5315” to the sequence 111. The completed sequence 111 for the keyword “SSN” thus comprises each of the values identified as potentially sensitive for the keyword, or detected as potential SSNs, indicated in the DLP detections 117.

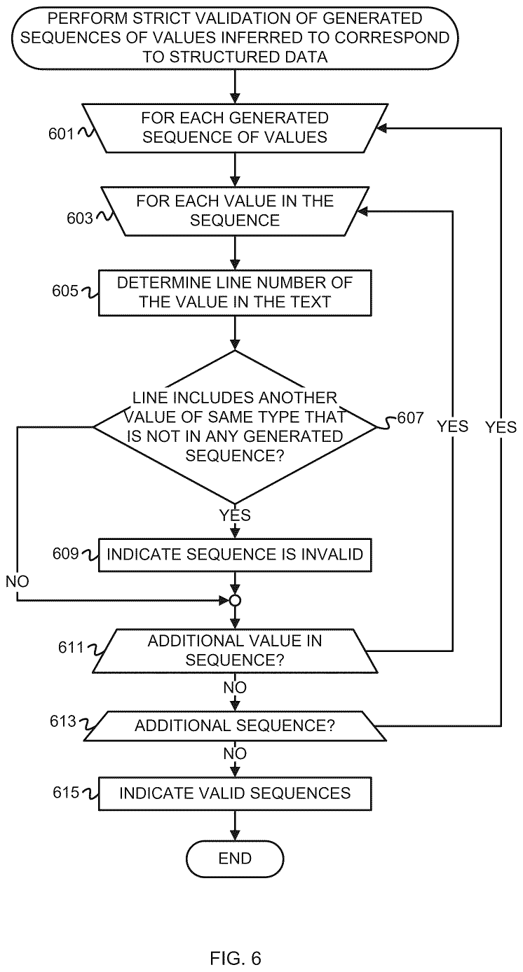

A sequence validator 107 of the system 101 validates the sequence 111 based on sequence validation criteria (“criteria”) 113. The criteria 113 comprise criteria for determining if a sequence is valid and thus has a high likelihood of corresponding to structured data within otherwise unstructured text. In this example, the criteria 113 comprise an indication of a minimum number of values with a configured value of three. In other words, sequences are valid if they comprise a number of values greater than or equal to the minimum indicated in the criteria 113. Since the sequence 111 comprises three values, the sequence validator 107 determines that the sequence 111 is valid and thus likely corresponds to structured data in the textual data 105. Implementations can leverage additional sequence validation criteria indicated in the criteria 113, and whether or not these criteria are enforced for sequence validation can be a configurable setting of the sequence validator 107 based on a desired “strictness” of validation. Strict validation is described below in further detail in reference to FIG. 6.

The system 101 indicates the sequence 111 for generation of DLP scanning results 119. For instance, the system 101 can indicate the sequence 111 to the DLP scanner 115 as likely corresponding to structured data within the textual data 105 to inform generation of the results 119, such as to inform generation of a confidence value for each of these detections. The DLP scanning results 119 indicate that the values identified in the sequence 111 were detected as SSNs in the textual data 105. The DLP scanning results 119 can further indicate a confidence in the SSN detection for the values indicated in the sequence 111, where the DLP scanner 115 computes a high degree of confidence in the detection based on receiving the indication from the system 101 that the values correspond to a sequence. Remediation and/or corrective action can then be taken for the values detected as SSNs in the DLP scanning results 119, such as blocking the corresponding network traffic, preventing uploading of the textual data 105, etc.

FIG. 2 is a conceptual diagram of determining that DLP detections within text extracted from a non-text-based file type correspond to structured data. As mentioned in reference to FIG. 1, FIG. 2 depicts an example in which the system 101 analyzes text extracted from a PNG file 203, named “ex1.png” in FIG. 2. The PNG file 203 comprises an image of a table that stores the same data described in reference to FIG. 1. FIG. 2 assumes that the text contents of the PNG file 203, including the text within the table depicted therein, have been extracted to generate extracted text 205. For instance, the DLP scanner 115 can extract the text from the PNG file 203 with OCR, can leverage an external service that performs OCR to obtain the extracted text 205, etc. The extracted text 205 includes each individual word extracted from the PNG file 203 is on its own line. A subset of the extracted text 205 is depicted in FIG. 2 as an example.

The DLP scanner 115 scans the extracted text 205 and generates DLP detections 217 indicating potentially sensitive data. This example assumes that the DLP detections 217 include the same keyword and values identified from the extracted text 205 as described in reference to FIG. 1 (i.e., the keyword “SSN” and values “078-05-1120”, “514-00-8905”, and “000-05-5315” identified as potential SSNs). The system 101 obtains the extracted text 205 and the DLP detections 217 as inputs.

The sequence builder 103 builds a sequence of values based on sequence addition criteria (“criteria”) 209. The criteria 209 comprise criteria for adding values identified in extracted text to a sequence corresponding to a keyword identified from DLP scanning. The criteria 209 differ from the criteria 109 described in reference to FIG. 1 because the criteria 209 are defined for evaluation of text extracted from original content, such as a PDF or an image file like the PNG file 203, and any structure of text represented in the content is not preserved as a result of the extraction. The criteria 209 include one or more criteria for positions between a keyword and values in the extracted text that, if satisfied, result in adding the values to a sequence built for the keyword. For instance, the criteria 209 can include a criterion indicating a maximum vertical distance (i.e., in terms of line numbers) between a keyword and corresponding value or between two values corresponding to the keyword; if this distance is exceeded (optionally subject to an error margin), the criterion is not satisfied. The criteria 209 can also indicate an error margin for the maximum vertical distance such that a distance between positions of a keyword and value or two values can be within a range established based on the maximum vertical distance to satisfy the vertical distance criterion. In this case, the range corresponds to the maximum vertical distance plus or minus the error margin.

The maximum vertical distance indicated in the criteria 209 can be dynamically determined based on a length of the “hop” from a keyword to the first value detected for the keyword. To illustrate, the sequence builder 103 identifies the keyword “SSN” on the third line of the extracted text 205. The sequence builder 103 determines that the first value identified for this keyword, the value “078-05-1120”, is on the eighth line of the extracted text 205. The sequence builder 203 thus identifies the length of the hop from the keyword “SSN” to the first value with a type of SSN is five, sets the maximum vertical distance to five plus or minus the error margin indicated in the criteria 209, and adds the value “078-05-1120” to a sequence 211 generated for the keyword “SSN”. The sequence builder 103 then expects the distance between the value “078-05-1120” and the next detected SSN in the extracted text 205 to be five plus or minus the configured error margin. As an example, for an error margin of two, the sequence builder 103 will determine that the next value, or “514-14-8905”, satisfies the criteria 209 if the length of the hop from “078-05-1120” to “514-14-8905” computed as the difference between their respective line numbers is within a range of three to seven. Because the vertical distance between these values is five, as the value “514-14-8905” is on the thirteenth line of the extracted text 205, the sequence builder 103 determines that the value satisfies the criteria 209 and adds the value “514-14-8905” to the sequence 211.

The sequence builder repeats the identification of values in the extracted text 205 corresponding to the keyword “SSN” and determination of whether the values satisfy the criteria 209 based at least partly on their positions relative to each other in the extracted text 205 until either a termination criterion is satisfied (e.g., based on a vertical distance between a detected value relative to the last value in the sequence falling outside of the established range or based on determining that a value is not the only text on its respective line) or until no more values corresponding to the keyword “SSN” in the DLP detections 217 remain for evaluation. This example assumes that the sequence builder 103 also identifies the value “000-05-5315” in the extracted text 205, determines that the criteria 209 are satisfied for this value, and adds this value to the sequence 211. The sequence 211 thus comprises each of the SSNs identified in the DLP detections 217.

The sequence validator 107 validates the sequence 211 based on sequence validation criteria (“criteria”) 213. Similar to the criteria 113 described in reference to FIG. 1, the criteria 213 comprise criteria for determining if a sequence identified in extracted text is valid and thus has a high likelihood of corresponding to structured data in the content from which the text was extracted. In this example, the criteria 213 also comprise an indication of a minimum number of values with a configured value of three. In other words, sequences are valid if they comprise a number of values greater than or equal to the minimum indicated in the criteria 213. Since the sequence 211 comprises three values, the sequence validator 107 determines that the sequence 211 is valid and thus likely corresponds to structured data in the PNG file 203.

The system 101 indicates the sequence 211 for generation of DLP scanning results 219. As similarly described in reference to FIG. 1, the system 101 can indicate the sequence 211 to the DLP scanner 115 for generation of the DLP scanning results 219. The DLP scanning results 219 indicate that the values identified in the sequence 211 were detected as SSNs for the PNG file 203. The DLP scanning results 219 can further indicate a confidence in the SSN detection for the values indicated in the sequence 211, where the DLP scanner 115 computes a high degree of confidence in the detection based on receiving the indication from the system 101 that the values correspond to a sequence. Remediation and/or corrective action can then be taken for the values detected as SSNs in the DLP scanning results 219.

FIGS. 1 and 2 depict examples in which one keyword is identified from DLP scanning of the respective content. Implementations can generate sequences for multiple keywords identified from DLP scanning. Additional criteria for adding values to a sequence can thus be enforced by the sequence builder 103. For instance, the sequence builder 103 can be configured with a criterion that a value can belong to a maximum of one sequence built for content being scanned. A value thus is not added to a sequence built for a keyword if the value has already been added to another previously-built sequence. As an illustrative example, with reference to FIG. 1, assume that a second instance of the keyword “SSN” is identified in the textual data 105 with an offset greater than the offset of the first instance of the keyword and the value “078-05-1120” having the offset of 130 is also detected in association with the second instance of the “SSN” keyword. The sequence builder 103 will determine that this value does not satisfy the criteria for adding the value to a sequence built for the second instance of the “SSN” keyword because the value was already added to the sequence 111 as described above.

FIGS. 1 and 2 depict two different approaches for inferring the presence of structured data in content submitted for DLP scanning. In implementations, the system 101 can apply each technique in sequence or in parallel to determine if the presence of structured data in content can be inferred from either technique. As another example, the system 101 can apply one of the techniques based on a type of content being submitted for DLP scanning (e.g., based on a determined file type). For instance, the system 101 can leverage the criteria 109, 113 of FIG. 1 based on determining that the content being scanned is a text file, word processing file, etc. or can leverage the criteria 209, 213 of FIG. 2 based on determining that the content being scanned is an image file, a PDF, another proprietary file type, etc. In both cases, the system 101 is configured with both the criteria 109, 209 and criteria 113, 213. Implementations can also leverage either technique but not both; for instance, implementations of the system 101 can be configured with either the criteria 109, 113 to perform the technique described in reference to FIG. 1 or the criteria 209, 213 to perform the technique described in reference to FIG. 2.

FIGS. 1 and 2 depict examples in which the system 101 executes as part of a DLP scanner. In implementations, the system 101 can execute separately but communicate with a DLP scanner that calls/invokes the system 101. For instance, the system 101 can execute on a server (e.g., a cloud-based or virtual server) external to the DLP scanner. As another example, the system 101 and DLP scanner can execute as separate services on the same server.

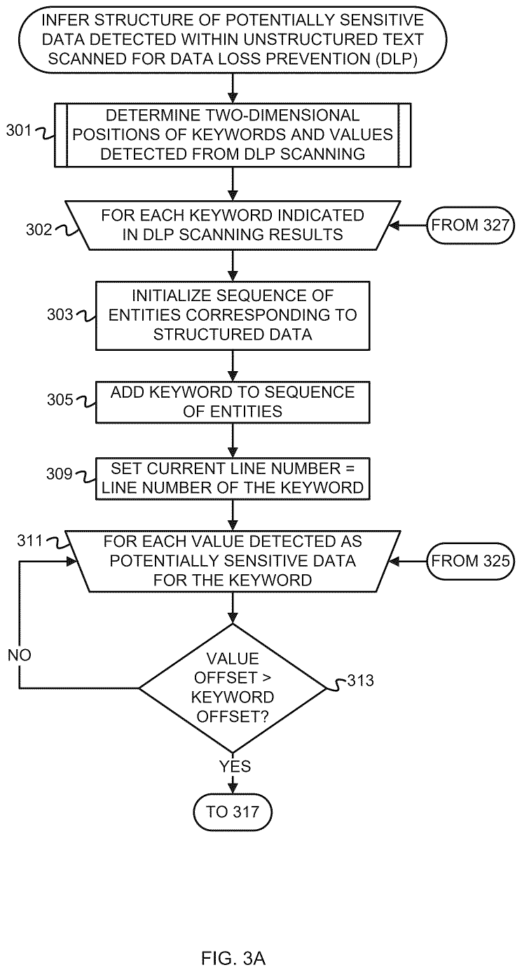

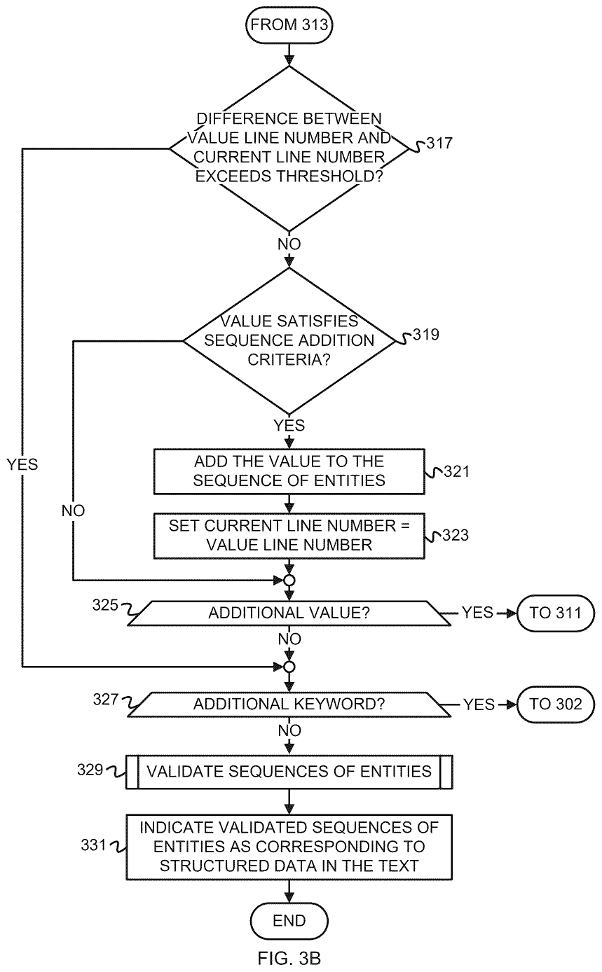

FIGS. 3A-3B, 4A-4C, and 5-6 are flowcharts of example operations. The example operations are described with reference to a structured data inferencing system (hereinafter “the inferencing system”) for consistency with the earlier figure(s) and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIGS. 3A-3B are a flowchart of example operations for inferring structure of potentially sensitive data detected within unstructured text scanned for DLP. The unstructured text scanned for DLP can be included in a text file, a word processing document, plaintext submitted by a user, etc. The example operations assume that the unstructured text has already been scanned for DLP and potentially sensitive data represented by a keyword indicating a type of sensitive data and one or more corresponding values of that type were detected.

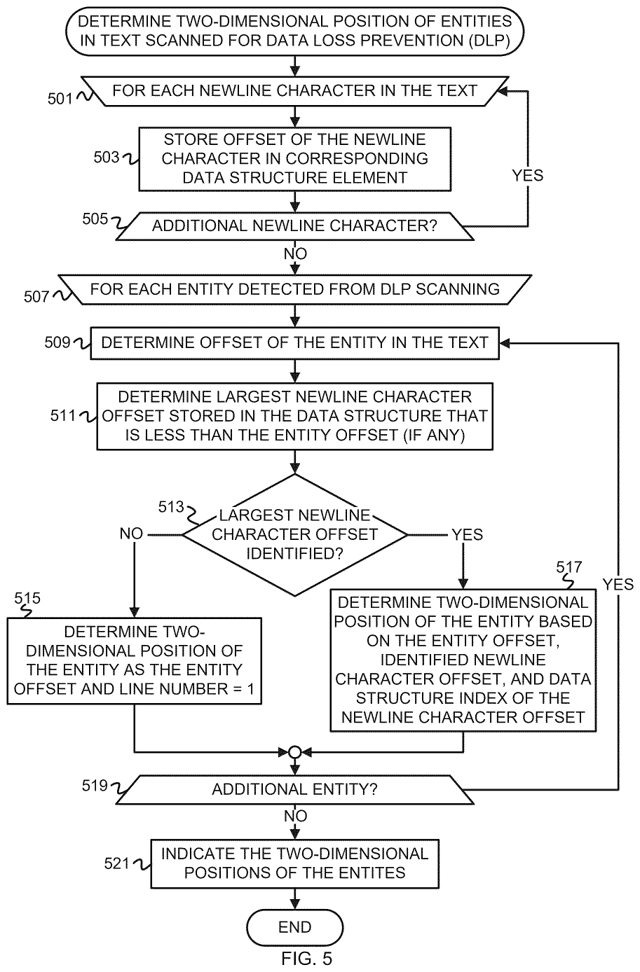

At block 301, the system determines two-dimensional positions of the keywords and values detected from DLP scanning. A two-dimensional position of a keyword or value refers to the line number of the text on which the keyword or value is located and an offset of the keyword or value on that line (or its “horizontal offset”). The DLP scanning results should indicate an offset of the keywords and values in the text that inform determination of two-dimensional positions. As a result of determining the two-dimensional positions of the keywords and values, the system will have access to a line number and offset in that line for each keyword and value detected from DLP scanning. Determining two-dimensional positions of keywords and values is described in further detail in reference to FIG. 5.

At block 302, the system begins iterating over keywords indicated in the DLP scanning results. The DLP scanning results indicate one or more keywords associated with potentially sensitive data identified in the scanned text (e.g., “SSN”, “credit card number”, etc.).

At block 303, the system initializes a sequence of entities corresponding to structured data. The system initializes a data structure in which it will store entities (i.e., keywords and values, if any) detected from DLP scanning that are inferred to be formatted as structured data in the scanned text.

At block 305, the system adds the keyword to the sequence of entities. The system stores the keyword in the sequence of entities, such as by storing the keyword in a first element of the data structure initialized for storing the sequence of entities.

At block 309, the system sets the current line number to the line number of the keyword. The system tracks a current line number as part of determining positions of keywords and associated values relative to each other. The system initializes the current line number with the line number of the keyword.

At block 311, the system begins iterating over values detected as potentially sensitive data for the keyword. Each keyword may have one or more values associated therewith in the DLP scanning results. For instance, for the keyword “SSN”, the DLP scanning results may indicate one or more potential SSNs identified in the text. Iteration over the values detected as potentially sensitive should be performed in ascending order of offset values.

At block 313, the system determines if an offset of the value in the text is greater than the offset of the keyword in the text. If the keyword and values are arranged in a tabular structure in which the keyword acts as a column header and the values are in rows below the keyword, the values should have higher offsets than the keyword due to occurring subsequent to the keyword in the text. If the offset of the value is less than the keyword offset, operations continue at block 311, as the value likely is not within a column corresponding to the keyword. Otherwise, operations continue at block 317 of FIG. 3B.

At block 317, the system determines if a difference between the value's line number and the current line number exceeds a threshold. The system maintains a threshold indicating a maximum permitted vertical distance between values in a sequence of values corresponding to structured data. For instance, for a threshold of two, if the value and either the keyword (for the first value in the sequence) or the previously-identified value in the sequence (i.e., the value corresponding to the previous iteration for values subsequent to the first in the sequence) are more than two lines apart from each other in the text, the value is considered not to be part of the sequence due to having substantial vertical distance from the keyword (for the first iteration corresponding to the keyword) or the previous value in the sequence (for iterations subsequent to the first). The threshold can be a preconfigured value of the system or can be dynamic. For a dynamic threshold, the value can be computed based on a number of values in the sequence of values; in other words, the threshold can be computed as a function of the number of values in the sequence. To illustrate, with a dynamic threshold, the threshold value computed for a sequence with five values can be less than the threshold value computed for a sequence with 30 values. The system may also enforce a maximum value of the dynamic threshold, such as a maximum of six such that the dynamic threshold that is computed does not exceed the maximum. If the difference between the value's line number and the current line number exceeds the threshold, the sequence is considered to be “broken,” and operations continue at block 329. Otherwise, operations continue at block 319.

At block 319, the system determines if the value satisfies sequence addition criteria. The criteria are defined for determining whether to add a value to the sequence built for the keyword. A first example criterion is a criterion that the value is not in any other sequences that have been previously built. In other words, values can be in a maximum of one sequence. A second example criterion is a criterion that a horizontal deviation of the value relative to the keyword based on offsets in their respective lines does not exceed a threshold. The system computes the absolute value of the difference between the offsets of the keyword and the value in their respective lines. The offsets of the keyword and value in their respective lines were determined as part of determining their respective two-dimensional positions. The threshold value can be a configured value of the system (e.g., a value of five) or can be dynamic. Like the dynamic line number threshold, the value of the threshold for within-line offsets can be computed based on the number of values in the sequence built for the keyword. The system may also enforce a maximum value of the dynamic threshold, such as a maximum of six such that the dynamic threshold that is computed does not exceed the maximum. For sequence addition criteria comprising these two criteria, the value satisfies the criteria if it is not in any previously-built chain for another keyword and if the horizontal deviation of the value from the keyword based on their respective horizontal offsets does not exceed the threshold. If the value satisfies the sequence addition criteria, operations continue at block 321. Otherwise, the value is not added to the sequence, and operations continue at block 325.

At block 321, the system adds the value to the sequence of entities. The system stores the value in the data structure that maintains the sequence.

At block 323, the system sets the current line number to the line number of the value. The system updates the current line number with the line number of the value determined as part of determining its two-dimensional position. For the subsequent iteration (if any), “the current line number” will refer to the line number corresponding to this value.

At block 325, the system determines if another value was detected for the keyword during DLP scanning. If another value was detected for the keyword, operations continue at block 311 of FIG. 3A. Otherwise, building the sequence for the keyword has been completed, and operations continue at block 327.

At block 327, the system determines if another keyword was detected from DLP scanning. If so, operations continue at block 302 of FIG. 3A. If not, operations continue at block 329.

At block 329, the system validates the sequences of entities. The system validates each sequence to ensure that the number of values in the sequence satisfies a minimum sequence length criterion (e.g., a minimum number of three values in a sequence). Sequences with fewer than the minimum number of values are not considered valid sequences for the purposes of structured data inferencing. The system determines the number of values in the sequence based on a size of the data structure minus one to account for the keyword's insertion in the sequence, based on an index number of the last-inserted value in the data structure for data structures with zero-based indexing, etc. Implementations can also apply “strict” validation, which is described in further detail in reference to FIG. 6. Whether the implementation performs length-based validation alone or strict validation can be a setting of the system indicated in its configuration. Sequences that are not validated can be discarded from subsequent operations.

At block 331, the system indicates the validated sequences of entities as corresponding to structured data in the text. The system can generate a report, notification, etc. indicating each of the generated and validated sequences of entities. These entities can then be designated as high-confidence DLP detections due to being inferred to correspond to structured data. The system may, for instance, provide the validated sequences of entities to the DLP scanner for additional processing and generation of results designating the entities indicated therein as high-confidence detections.

While FIG. 3 depicts an example in which the system takes one “pass” over a keyword and the values detected for the keyword for building a sequence, implementations can perform multiple passes with varying values of a position criterion(a) based on the length of a sequence that has been built from the first pass. For instance, the system can be configured with a default value of the threshold maintained for the horizontal deviation criterion (e.g., a default value of 35). During the first pass through building the sequence, the system evaluates differences horizontal offsets of a keyword and each value based on this default threshold value. After building the sequence (e.g., between blocks 325 and 327 of FIG. 3B), the system determines a number of values in the sequence and evaluates the number of values based on an additional sequence length threshold. If the number of values in the sequence satisfies the threshold, such as if there are at least 30 values in the sequence, this may be indicative that the content submitted for scanning comprises a larger table or other set of data in the original content but also may be indicative that the default threshold was too lax during the first pass. The system can then perform an additional pass over the keyword and corresponding values with a stricter horizontal deviation threshold (e.g., a threshold with a value of 15) and re-builds the sequence based on the stricter threshold.

FIG. 3 describes an example in which the keyword is added to the sequence of entities that comprises the keyword itself and values detected for that keyword. Implementations can associate the keyword with a sequence of values through other techniques, such as by labelling, tagging, etc. the data structure that maintains a sequence of values with the keyword. In this case, the sequence is a sequence of values (as opposed to a sequence of entities that includes the keyword and the corresponding values).

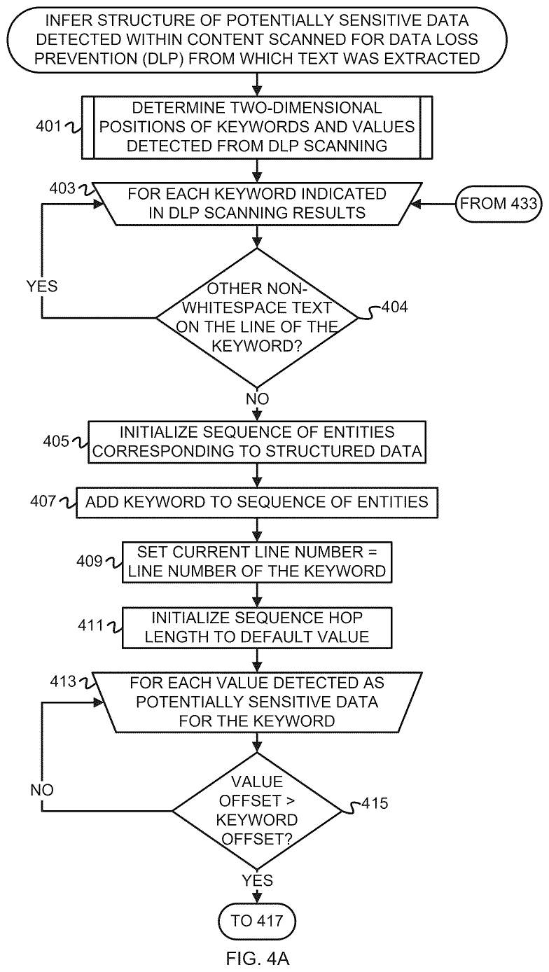

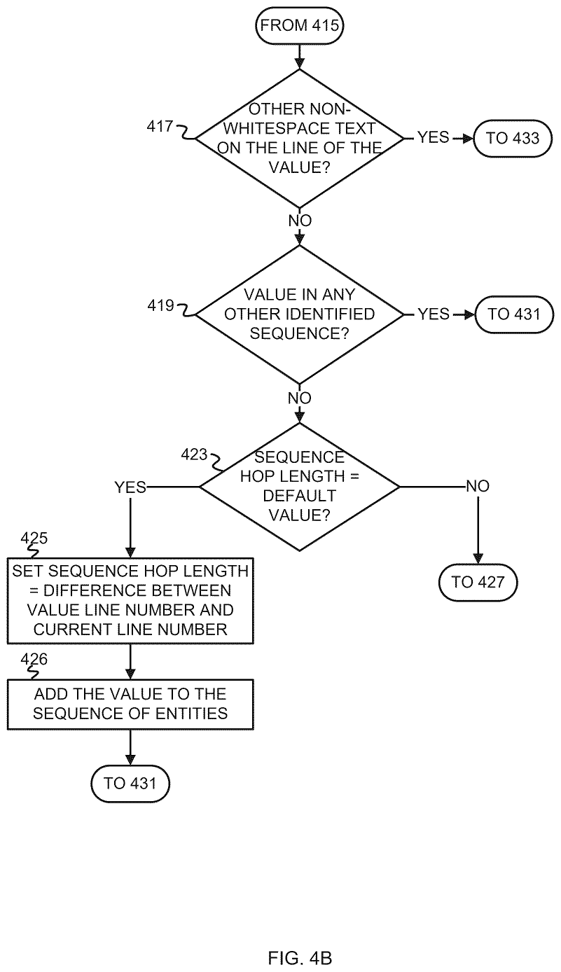

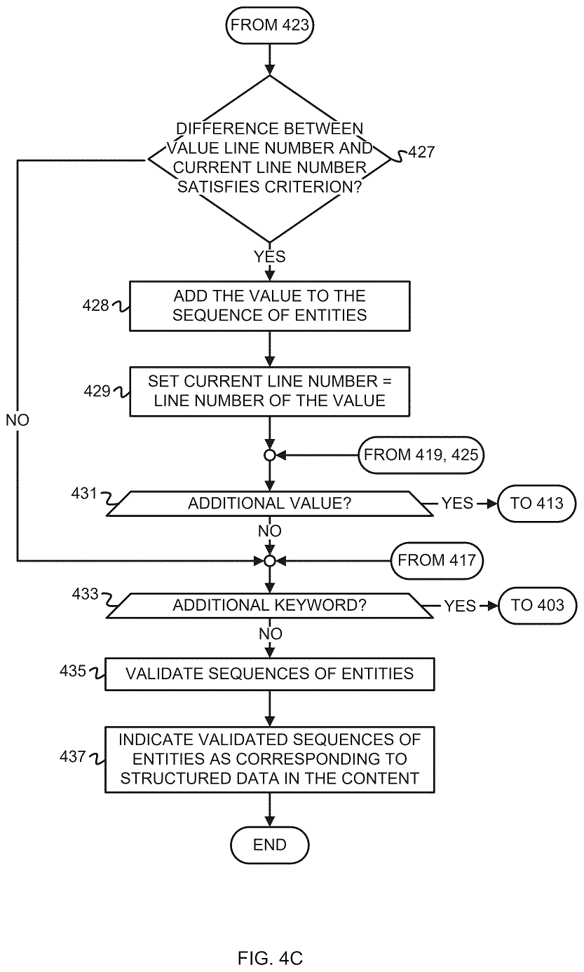

FIGS. 4A-4C are a flowchart of example operations for inferring structure of potentially sensitive data detected within content from which text was extracted for DLP scanning. The content from which text was extracted can be an image file, a PDF file, a file with another proprietary file format, etc., where the text included therein cannot readily be processed as text. The example operations assume that the text has been extracted from the content submitted for DLP scanning (e.g., via OCR). The example operations also assume that the unstructured text has already been scanned for DLP and potentially sensitive data represented by a keyword indicating a type of sensitive data and one or more corresponding values of that type were detected. Subject matter that is repeated between FIGS. 3A-3B and FIGS. 4A-4C is omitted for brevity.

At block 401, the system determines two-dimensional positions of the keywords and values detected from DLP scanning. As described in reference to block 301 of FIG. 3A, a two-dimensional position of a keyword or value refers to the line number of the text on which the keyword or value is located and an offset of the keyword or value on that line. Determining two-dimensional positions of keywords and values is described in further detail in reference to FIG. 5.

At block 403, the system begins iterating over keywords indicated in the DLP scanning results. At block 404, the system determines if there is other non-whitespace text on the line in the text to which the keyword corresponds. If there is other text on the line of the keyword (excluding whitespace), the keyword likely is not represented as part of structured data in the original content. The system searches the line of the text to which the keyword corresponds to determine if there is any other non-whitespace text present on the line. If there is other non-whitespace text on the line, operations continue at block 403. Otherwise, operations continue at block 405.

At block 405, the system initializes a sequence of entities corresponding to structured data. At block 407, the system adds the keyword to the sequence of entities. At block 409, the system sets the current line number to the line number of the keyword.

At block 411, the system initializes a sequence hop length to a default value. The sequence hop length is a variable that stores a length of an expected “hop” in the text between keywords and corresponding values. To illustrate, if the keyword “SSN” is on line 10 of the extracted text and a first suspected SSN is on line 14, then the sequence hop length is four. The default value should be a value that cannot be identified as a valid hop length (e.g., a value of 0 or -1).

At block 413, the system begins iterating over values detected as potentially sensitive data for the keyword. Iteration over the values detected as potentially sensitive should be performed in ascending order of offset values.

At block 415, the system determines if an offset of the value in the text is greater than the offset of the keyword in the text. If the offset of the value is less than the keyword offset, operations continue at block 413, as the value likely is not within a column corresponding to the keyword. Otherwise, operations continue at block 417 of FIG. 4B.

At block 417, the system determines if there is other non-whitespace text on the line to which the value corresponds. The system searches the line of the extracted text to which the value corresponds to determine if the value is the only text on the line (barring whitespace). Text in addition to the value on the same line is indicative that the value is not represented as part of structured data in the original content. If there is other non-whitespace text on the line, operations continue at block 433 of FIG. 4C. If not, operations continue at block 419.

At block 419, the system determines if the value is any other identified sequence. The system searches the previously-built sequences, if any, for the value to determine if it has already been added to a sequence. If the value is in another identified sequence, operations continue at block 431 of FIG. 4C. If not, operations continue at block 421, where the system adds the value to the sequence of entities.

At block 423, the system determines if the sequence hop length is set to the default value. Whether the sequence hop length is set to the default value informs whether another value has already been identified in a sequence for the keyword. If the hop length is set to the default value, operations continue at block 425. If not, operations continue at block 427 of FIG. 4C.

At block 425, the system sets the sequence hop length to the difference between the line number of the value and the current line number. The system updates the value of the sequence hop length to the difference between the line number identified for the value and the current line number (i.e., the variable initialized at block 409 with the keyword line number). At block 426, the system adds the value to the sequence of entities. Operations continue at block 431 of FIG. 4C.

At block 427, the system determines if the difference between the value line number and the current line number satisfies a criterion. The system determines if a deviation of the value's line number from the current line number, which corresponds to either the keyword or a previous value in the sequence from a corresponding previous iteration, is within a designated margin of an expected value. The expected value can be the sequence hop length. The designated margin can be a preconfigured value (e.g., a value of three) of the sequence or can be dynamically determined, such as based on the number of values in the sequence determined thus far. The difference between the value line number and the current line number satisfies the criterion if the difference is within a range established by the sequence hop length plus or minus the designated margin. To illustrate, for a sequence hop length of six and a margin of three, the difference satisfies the criterion if it falls within a range of three to nine. If the difference satisfies the criterion, operations continue at block 428. Otherwise, operations continue at block 433.

At block 428, the system adds the value to the sequence of entities. At block 429, the system sets the current line number to the line number of the value. At block 431, the system determines if another value was detected for the keyword during DLP scanning. If so, operations continue at block 413 of FIG. 4A. If no other values were detected for the keyword, operations continue at block 433.

At block 433, the system determines if another keyword was detected from DLP scanning. If another keyword was detected, operations continue at block 403 of FIG. 4A. If not, operations continue at block 435.

At block 435, the system validates the sequences of entities. The system validates each sequence to ensure that the number of values in the sequence satisfies a minimum sequence length criterion. Sequences with fewer than the minimum number of values are not considered valid sequences for the purposes of structured data inferencing. Sequences that are not validated can be discarded from subsequent operations. At block 437, the system indicates the validated sequences of entities as corresponding to structured data in the text.

FIG. 5 is a flowchart of example operations for determining a two-dimensional position of entities in text scanned for DLP. The text can be text included in a text document or word processing document, text input by a user, etc. The text can also be text extracted from a file of a non-text file type submitted for DLP scanning (e.g., images, PDF files, etc.). An “entity” refers to a keyword identified from DLP scanning or a value detected as potentially sensitive from DLP scanning.

At block 501, the system begins iterating over newline characters identified in the text. Newline characters are those that designate the end of the current line.

At block 503, the system stores an offset of the newline character in a corresponding data structure element. If the newline character is the first in the text, the system initializes a data structure and stores the newline character offset in the first (e.g., at index zero for zero-based indexing) element of the data structure. The newline character offsets are stored in the data structure such that the line number to which the newline character offset corresponds can be discerned based on the index of the respective data structure elements, so order of discovery of newline character offsets is maintained in the data structures.

At block 505, the system determines if there is another newline character. If there is another newline character, operations continue at block 501. If not, and the system has reached the end of the text, operations continue at block 507.

At block 507, the system begins iterating through entities detected from DLP scanning. Entities include keywords known to be indicative of sensitive data and values detected as being potentially sensitive.

At block 509, the system determines an offset of the entity in the text. The offset of the entity in the text refers to its offset relative to the beginning of the text, or the character number in the text as a whole at which the entity starts.

At block 511, the system determines a largest newline character offset stored in the data structure that is less than the entity offset (if any). The system compares the entity offset to the newline character offsets stored in the data structure and determines the largest newline character offset stored therein that does not exceed the entity offset (if any). To illustrate, if the entity offset is 56 and the newline character offsets stored in the first three elements of the data structure are 15, 36, and 62, then the largest newline character offset that is less than the entity offset is the offset of 36 stored in the second element of the data structure. If there is no such newline character offset, the entity is in the first line of the text.

At block 513, the system determines if a largest newline character offset was identified. If no newline character offset smaller than the entity offset was identified, then the entity is on the first line of the text, and operations continue at block 515. Otherwise, operations continue at block 517.

At block 515, the system determines the two-positional position of the entity as the entity offset and a line number of one. Since the entity is on the first line, its vertical position indicating the line number of the entity in the text is one, and its horizontal position indicating the offset of the entity in its corresponding line in the text is its offset in the text. The system associates an indication of the two-dimensional position with the entity (e.g., through labelling, tagging, updating a data structure or file with the entity and its position, etc.).

At block 517, the system determines the two-dimensional position of the entity based on the entity offset, the identified newline character offset, and the index in the data structure of the newline character offset. The system computes the vertical position indicating the line number of the entity in the text based on the index of the data structure in which the largest newline character preceding the entity in the text was identified. In zero-based indexed data structures, the line number of the entity is computed as the index at which the newline character offset was stored plus two. In one-based indexed data structures, the line number of the entity is computed as the index at which the newline character offset was stored plus one. To illustrate, for an entity where the newline character with a largest offset less than the entity offset is stored in the third element of the data structure (which has an index of 2 in zero-based indexing or 3 in one-based indexing), the newline character was thus identified on the third line of the text, so the entity can be determined to be on the fourth line of the text. The horizontal position indicating the offset of the entity in its corresponding line in the text is computed as the difference between the entity's offset in the text and the identified newline character offset stored in the data structure. The system associates an indication of the two-dimensional position with the entity.

At block 519, the system determines if there is an additional entity detected from DLP scanning. If so, operations continue at block 507. Otherwise, operations continue at block 521.

At block 521, the system indicates the two-dimensional positions of the entities. The system can generate a report or notification indicating the entities and their corresponding positions, can make available a data structure or file that stores the entities and their corresponding positions, etc.

FIG. 6 is a flowchart of example operations for performing strict validation of generated sequences of values inferred to correspond to structured data. Strict validation serves to identify sequences of values with values that are part of clusters of values in the text rather than true structured data (e.g., a table). Whether the system performs strict validation of generated sequences in addition to the length-based validation described above can be a configurable setting of the system.

At block 601, the system begins iterating over generated sequences of values. The sequences were generated as described in reference to FIGS. 3A-3B.

At block 603, the system begins iterating over values in the sequence. The sequence comprises a plurality of values corresponding to potentially sensitive data identified from DLP scanning.

At block 605, the system determines a line number of the value in the text. The system previously determined the line number to which each value corresponds as part of determining two-dimensional positions of the values.

At block 607, the system determines if the line includes another value of the same type that is not in any generated sequence. The system determines if any of the values detected as potentially sensitive from DLP scanning are on the same line number as the value (i.e., are associated with the same line number) but are not part of any of the generated sequences. This check ensures that there are no values without sequence membership on the same line as a value that is part of a sequence, as this may be indicative of the presence of an unstructured cluster of values rather than structured data. If the line includes another value of the same type that is not any generated sequence, operations continue at block 609. Otherwise, operations continue at block 611.

At block 609, the system indicates that the sequence is invalid. The system can remove the sequence from the set of generated sequences, associate a label, tag, or other indication of invalidity with the sequence, etc.

At block 611, the system determines if there is an additional value in the sequence remaining. If there is an additional value in the sequence remaining, operations continue at block 603. If not, operations continue at block 613.

At block 613, the system determines if there is an additional sequence remaining for validation. If there is an additional sequence remaining, operations continue at block 601. If not, operations continue at block 615.

At block 615, the system indicates the valid sequences. The system can generate a report or notification comprising the valid sequences, can label, tag, or otherwise designate the sequences as valid, etc.

### Variations

This description refers to examples of structured data such as tables where headers in the structured data that may correspond to keywords detected from DLP are arranged horizontally with respect to each other. In other words, headers are arranged in the same row, with values corresponding to a header located in a column corresponding to the header. Implementations can also identify structured data in which headers are arranged vertically. For instance, headers of a table may be located in a same column, with values corresponding to a header located in a row corresponding to the header.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

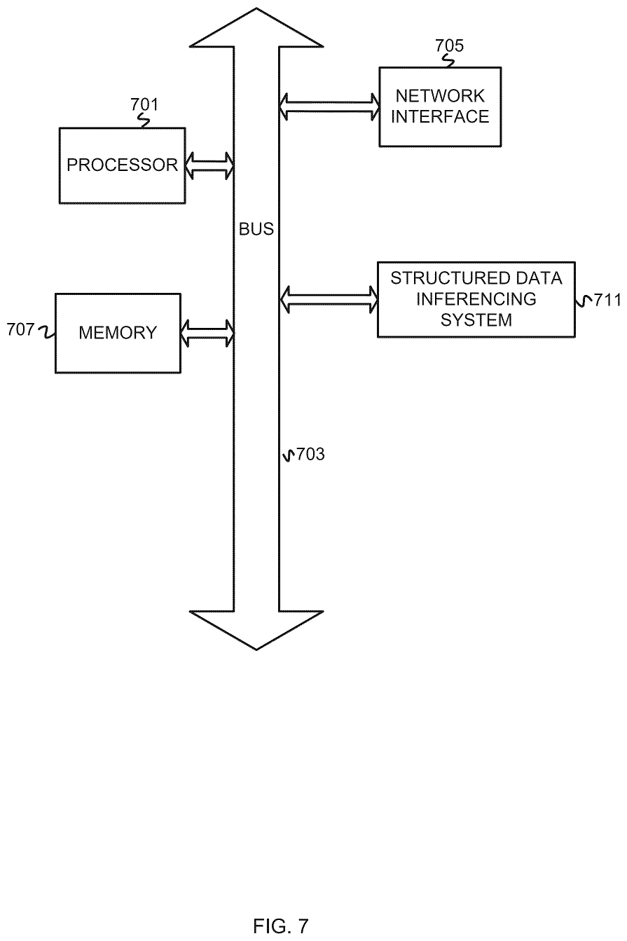

FIG. 7 depicts an example computer system with a structured data inferencing system. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes structured data inferencing system 711. The structured data inferencing system 711 infers that a keyword and corresponding values identified as potentially sensitive from DLP scanning correspond to structured data within the content submitted for scanning based on positions of the keyword and values relative to each other in text corresponding to the content that was scanned for DLP. The text may be a text-based file, plaintext, or text extracted from a non-text-based file type. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
identifying a keyword detected from data loss prevention (DLP) scanning of first content;
determining a plurality of values detected as potentially sensitive from the DLP scanning that correspond to the keyword;
determining that the plurality of values comprises a sequence of values corresponding to structured data within the first content based on positioning of each of a subset of the plurality of values corresponding to the sequence of values relative to at least one of the keyword and a first value of the subset of values; and
indicating those of the plurality of values corresponding to the sequence of values as high confidence detections for the first content.

2. The method of claim 1, wherein the first content comprises structured data within unstructured text.

3. The method of claim 2, wherein determining that the plurality of values comprises the sequence of values corresponding to structured data comprises, for a first value of the plurality of values,
determining a position of the keyword in the first content, wherein the position of the keyword comprises at least one of a first line number and a first offset value;
determining a position of the first value in the first content, wherein the position of the first value comprises at least one of a second line number and a second offset value; and
based on determining that a difference between the position of the keyword and the position of the first value satisfies one or more criteria, adding the first value to the sequence of values.

4. The method of claim 3, wherein determining that the difference between the position of the keyword and the position of the first value satisfies the one or more criteria comprises at least one of determining that a difference between the first and second line numbers does not exceed a first threshold and determining that a difference between the first and second offset values does not exceed a second threshold.

5. The method of claim 3, further comprising:
determining a position of a second value of the plurality of values in the first content, wherein the position of the second value comprises at least one of a third line number and a third offset value; and
based on determining that a difference between the position of the first value and at least one of the position of the second value and the position of the keyword satisfies the one or more criteria, adding the second value to the sequence of values.

6. The method of claim 5, further comprising repeating the determining of positions of subsequent ones of the plurality of values relative to corresponding preceding ones of the plurality of values, determining differences between positions of values, and adding of values to the sequence of values until determining that a difference between positions of values does not satisfy the one or more criteria.

7. The method of claim 1, wherein the first content comprises text extracted from an image or from a file with a proprietary file format.

8. The method of claim 7, wherein determining that the plurality of values comprises the sequence of values corresponding to structured data comprises, for a first value of the plurality of values, based on determining that a line in the first content in which the first value was identified comprises no other text, adding the first value to the sequence of values.

9. The method of claim 8, further comprising,
determining that a line in the first content in which a second value of the plurality of values was identified comprises no other text; and
based on determining that a difference between a position of the second value in the first content and a position of the first value in the first content satisfies a criterion, adding the second value to the sequence of values.

10. The method of claim 9, further comprising repeating the determining of differences between positions of subsequent ones of the plurality of values relative to corresponding preceding ones of the plurality of values and adding of values to the sequence of values until determining that a difference between positions exceeds the first threshold or determining that a subsequent one of the plurality of values corresponds to a line of the first content that comprises other text.

11. One or more non-transitory machine-readable media having program code stored thereon, the program code comprising instructions to:
identify one or more keywords detected from data loss prevention (DLP) scanning of first content; and
for each keyword of the one or more keywords,
determine a plurality of values detected as potentially sensitive from the DLP scanning that correspond to the keyword;
infer that at least a subset of the plurality of values correspond to structured data within the first content based on positions of each of the subset of values relative to at least one of the keyword and another value in the subset of values; and
indicate the subset of values inferred to correspond to structured data as high confidence detections for the first content.

12. The non-transitory machine-readable media of claim 11, wherein the first content is unstructured textual data that comprises structured data, wherein the instructions to infer that the subset of values corresponds to structured data comprise instructions to,
determine a position of the keyword in the first content;
for each of the subset of values,
determine a position of the value in the first content; and
determine that a difference between the position of the value and at least one of the position of the keyword and a position of a preceding value in the subset of values satisfies one or more criteria.

13. The non-transitory machine-readable media of claim 12,
wherein the instructions to determine the position of the keyword comprise instructions to determine at least one of a first line number and a first offset value of the keyword in the first content,
wherein the instructions to determine the position of the value comprise instructions to determine at least one of a second line number and a second offset value of the value in the content.

14. The non-transitory machine-readable media of claim 11, wherein the first content comprises text extracted from an image or from a file with a proprietary file format. wherein the instructions to infer that the subset of the plurality of values correspond to structured data comprise instructions to,
determine that a line in the first content in which a first value in the subset of values was identified comprises no other text;
determine that a line in the first content in which a second value of the subset of values was identified comprises no other text; and
determine that a difference between a position of the second value in the first content and a position of the first value in the first content satisfies a criterion.

15. An apparatus comprising:
a processor; and
a machine-readable medium having instructions stored thereon that are executable by the processor to cause the apparatus to,
identify a keyword detected from data loss prevention (DLP) scanning of first content;
determine a plurality of values detected as potentially sensitive from the DLP scanning that correspond to the keyword;
determine that the plurality of values comprises a sequence of values corresponding to structured data within the first content based on positioning of each of a subset of the plurality of values corresponding to the sequence of values relative to at least one of the keyword and a first value of the subset of values; and
indicate those of the plurality of values corresponding to the sequence of values as high confidence detections for the first content.

16. The apparatus of claim 15, wherein the first content is a text-based file, wherein the instructions executable by the processor to cause the apparatus to determine that the plurality of values comprises the sequence of values corresponding to structured data comprise instructions executable by the processor to cause the apparatus to, for a first value of the plurality of values,
determine a position of the keyword in the first content, wherein the position of the keyword comprises at least one of a first line number and a first offset value;
determine a position of the first value in the first content, wherein the position of the first value comprises at least one of a second line number and a second offset value; and
based on a determination that a difference between the position of the keyword and the position of the first value satisfies one or more criteria, add the first value to the sequence of values.

17. The apparatus of claim 16, wherein the instructions executable by the processor to cause the apparatus to determine that the difference between the position of the keyword and the position of the first value satisfies the one or more criteria comprise at least one of instructions executable by the processor to cause the apparatus to determine that a difference between the first and second line numbers does not exceed a first threshold and instructions executable by the processor to cause the apparatus to determine that a difference between the first and second offset values does not exceed a second threshold.

18. The apparatus of claim 16, further comprising instructions executable by the processor to cause the apparatus to:
determine a position of a second value of the plurality of values in the first content, wherein the position of the second value comprises at least one of a third line number and a third offset value; and
based on a determination that a difference between the position of the first value and at least one of the position of the second value and the position of the keyword satisfies the one or more criteria, add the second value to the sequence of values.

19. The apparatus of claim 15, wherein the first content comprises text extracted from an image or from a file with a proprietary file format, wherein the instructions executable by the processor to cause the apparatus to determine that the plurality of values comprises the sequence of values corresponding to structured data comprise instructions executable by the processor to cause the apparatus to, for a first value of the plurality of values, based on a determination that a line in the first content in which the first value was identified comprises no other text, add the first value to the sequence of values.

20. The apparatus of claim 19, further comprising instructions executable by the processor to cause the apparatus to:
determine that a line in the first content in which a second value of the plurality of values was identified comprises no other text; and
based on a determination that a difference between a position of the second value in the first content and a position of the first value in the first content satisfies a criterion, add the second value to the sequence of values.
